(19) United States
(12) Patent Application Publication
(10) Pub. No.: US 2007/0071438 A1
(43) Pub. Date: Mar. 29, 2007

(54) Handheld electronic device including a rotatable camera unit

(75) Inventors: Baron Huang, Chang-Hua Hsien (TW); Jen-Yu Lee, Nan-Tou Hsien (TW); Fei-Mi Su, Chang-Hua Hsien (TW); Shun-Fu Chen, Chang-Hua Hsien (TW)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Universal Scientific Industrial Co., Ltd., Nan-Tou Hsien (TW)

(21) Appl. No.: 11/237,310

(22) Filed: Sep. 27, 2005

(51) Int. Cl. G03B 17/02

(52) U.S. Cl. 396/535

(57) ABSTRACT

A handheld electronic device includes a casing, a camera unit, and a sealing unit. The casing confines an accommodating space, and is formed with a recess that is defined by a recess-defining wall. The recess-defining wall is formed with a hole that is in spatial communication with the recess and the accommodating space. The camera unit includes a camera housing and an electrical wire. The camera housing is disposed in the recess, and has a first end portion that is received rotatably in the hole in the recess-defining wall. The electrical wire has a first end portion that extends into the camera housing, and a second end portion that extends into the accommodating space. The sealing unit is disposed between and is in airtight contact with the recess-defining wall and the camera housing.

### BACKGROUND OF THE INVENTION

1. Field of the Invention

This invention relates to a handheld electronic device, more particularly to a handheld electronic device that includes a camera unit.

2. Description of the Related Art

A conventional handheld electronic device includes a casing and a camera unit. The casing confines an accommodating space, and is formed with a recess that is defined by a recess-defining wall. The recess-defining wall of the casing has a first wall portion, and a second wall portion that is opposite to the first wall portion. The first wall portion of the recess-defining wall is formed with a hole that is in spatial communication with the recess and the accommodating space.

The camera unit includes a camera housing and an electrical wire. The camera housing is disposed in the recess, and has a first end portion that is received rotatably in the hole in the first wall portion of the recess-defining wall of the casing, and a second end portion that is coupled rotatably to the second wall portion of the recess-defining wall of the casing. The electrical wire has a first end portion that extends into the camera housing, and a second end portion that extends into the accommodating space in the casing.

The aforementioned conventional handheld electronic device is disadvantageous in that a gap exists between the camera housing and a periphery of the hole in the first wall portion of the recess-defining wall of the casing. As such, water or vapor can easily enter the accommodating space through the gap, and can may cause the electronic device to malfunction.

### SUMMARY OF THE INVENTION

Therefore, the object of the present invention is to provide a handheld electronic device that includes a camera unit and that can overcome the aforesaid drawback of the prior art.

According to the present invention, a handheld electronic device comprises a casing, a camera unit, and a sealing unit. The casing confines an accommodating space, and is formed with a recess that is defined by a recess-defining wall. The recess-defining wall has a first wall portion that has first and second surfaces, and a second wall portion opposite to the first wall portion. The first wall portion of the recess-defining wall is formed with a hole that extends between the first and second surfaces of the first wall portion of the recess-defining wall and that is in spatial communication with the recess and the accommodating space. The camera unit includes a camera housing and an electrical wire. The camera housing is disposed in the recess, and has a first end portion that is received rotatably in the hole in the first wall portion of the recess-defining wall. The electrical wire has a first end portion that extends into the camera housing, and a second end portion that extends into the accommodating space. The sealing unit is disposed between and is in airtight contact with the first surface of the first wall portion of the recess-defining wall and the camera housing.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a handheld electronic device according to the present invention;

FIG. 2 is an exploded perspective view of the preferred embodiment; and

FIG. 3 is a fragmentary schematic sectional view to illustrate a camera unit of the preferred embodiment.

### DETAILED DESCRIPTION OF THE PREFERRED EMBODIMENT

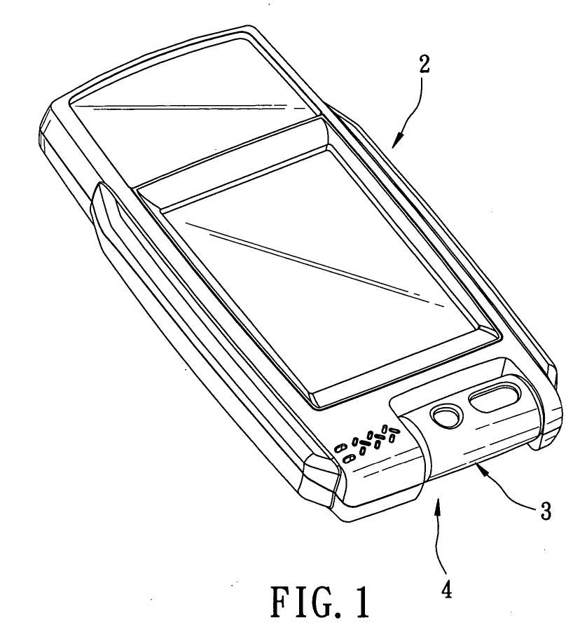

Referring to FIG. 1, the preferred embodiment of a handheld electronic device according to this invention is shown to include a casing 2, a camera unit 3, and a sealing unit 4.

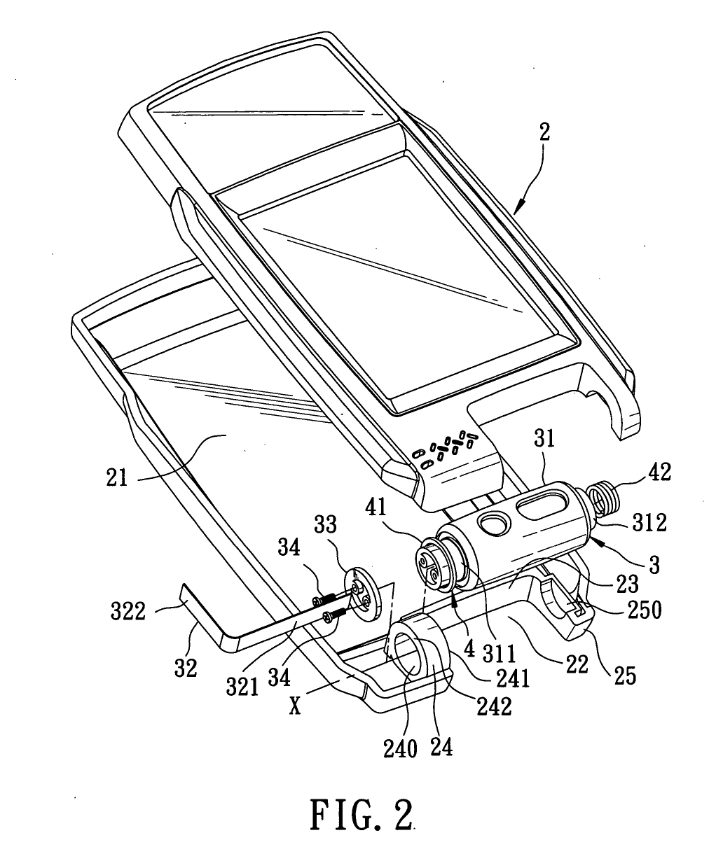

With further reference to FIG. 2, the casing 2 confines an accommodating space 21, and is formed with a recess 22 that is defined by recess-defining wall 23. The recess-defining wall 23 has a first wall portion 24, and a second wall portion 25 that is opposite to the first wall portion 24. The first wall portion 24 of the recess-defining wall 23 has opposite first and second surfaces 241, 242, and is formed with a hole 240 that extends between the first and second surfaces 241, 242 of the first wall portion 24 of the recess-defining wall 23, that is in spatial communication with the accommodating space 21 and the recess 22, and that has a hole axis (X). The second wall portion 25 of the recess-defining wall 23 is formed with a first groove 250 that is defined by a first groove-defining wall.

The camera unit 3 includes a camera housing 31 and an electrical wire 32. The camera housing 31 is disposed in the recess 23, is rotatable relative to the casing 2 about the hole axis (X), and has first and second end portions 311, 312 that are opposite each other along the hole axis (X). The first end portion 311 of the camera housing 31 is received rotatably in the hole 240 in the first wall portion 24 of the recess-defining wall 23. The second end portion 312 of the camera housing 31 is received rotatably in the first groove 250 in the second wall portion 25 of the recess-defining wall 23. The electrical wire 32 has a first end portion 321 that extends into the camera housing 31, and a second end portion 322 that extends into the accommodating space 21.

The sealing unit 4 includes an annular gasket 41 that is made of a rubber material, that is sleeved on the first end portion 311 of the camera housing 31, and that is disposed between and that is in airtight contact with the first surface 241 of the first wall portion 24 of the recess-defining wall 23 and the camera housing 31. Accordingly, water or vapor can be prevented from entering the accommodating space 21 between the first surface 241 of the first wall portion 24 of the recess-defining wall 23 and the camera housing 31.

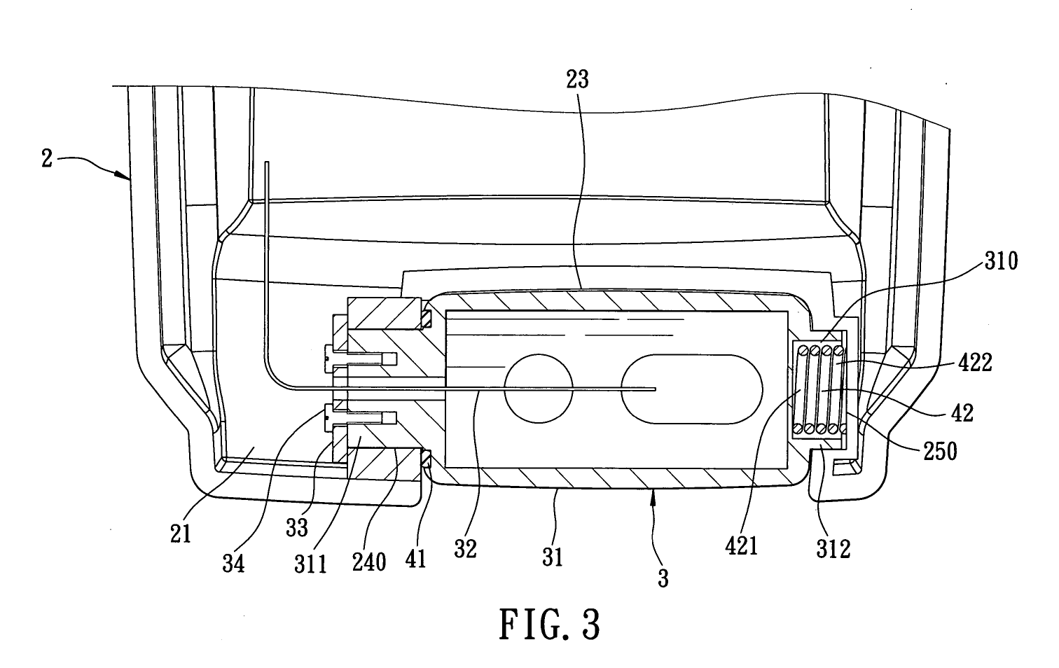

With further reference to FIG. 3, the electronic device further includes a biasing member 42 that is disposed between the second wall portion 25 of the recess-defining wall 23 and the camera housing 31, and that biases the camera housing 31 toward the first wall portion 24 of the recess-defining wall 23. In particular, the second end portion 312 of the camera housing 31 is formed with a second groove 310 that is defined by a second groove-defining wall. The biasing member 42 is disposed in the second groove 310 in the second end portion 312 of the camera housing 31, and has opposite ends 421, 422, each of which abuts against a respective one of the first and second groove-defining walls. In this embodiment, the biasing member 42 is a compression spring.

It is noted that the biasing member 42 maintains the airtight contact of the gasket 41 of the sealing unit 4 with the first surface 241 of the first wall portion 24 of the recess-defining wall 23 and the camera housing 31. As such, the camera housing 31 may be adjusted and retained at a desired angular position with respect to the casing 2.

The electronic device further includes a securing unit for securing the camera housing 31 on the first wall portion 24 of the recess-defining wall 23. In this embodiment, the securing unit includes an anchoring piece 33 and a pair of fastening members 34. The anchoring piece 33 is formed with a pair of holes therein, and is anchored to the second surface 242 of the first wall portion 24 of the recess-defining wall 23. Each of the fastening members 34 extends through a respective one of the holes in the anchoring piece 33 and threadedly engages the first end portion 311 of the camera housing 31.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A handheld electronic device, comprising:
a casing confining an accommodating space, and formed with a recess that is defined by a recess-defining wall, said recess-defining wall having a first wall portion that has first and second surfaces, and a second wall portion opposite to said first wall portion, said first wall portion of said recess-defining wall being formed with a hole that extends from said first surface to said second surface of said first wall portion of said recess-defining wall and that is in spatial communication with said recess and said accommodating space;
a camera unit disposed in said recess, and including
a camera housing having a first end portion that is received rotatably in said hole in said first wall portion of said recess-defining wall, and
an electrical wire having a first end portion that extends into said camera housing, and a second end portion that extends into said accommodating space; and
a sealing unit disposed between and in airtight contact with said first surface of said first wall portion of said recess-defining wall and said camera housing.

2. The handheld electronic device as claimed in claim 1, further comprising a biasing member that is disposed between said second wall portion of said recess-defining wall and said camera housing, and that biases said camera housing toward said first wall portion of said recess-defining wall.

3. The handheld electronic device as claimed in claim 1, wherein said camera housing further has a second end portion that is opposite to said first end portion of said camera housing, and that is coupled rotatably to said second wall portion of said recess-defining wall.

4. The handheld electronic device as claimed in claim 3, wherein said second wall portion of said recess-defining wall of said casing is formed with a first groove that is defined by a first groove-defining wall, said second end portion of said camera housing being received rotatably in said first groove in said second wall portion of said recess-defining wall.

5. The handheld electronic device as claimed in claim 4, wherein said second end portion of said camera housing is formed with a second groove that is defined by a second groove-defining wall, said handheld electronic device further comprising a biasing member that is disposed in said second groove in said second end portion of said camera housing, and that has opposite ends, each of which abuts against a respective one of said first and second groove-defining walls.

6. The handheld electronic device as claimed in claim 1, further comprising a securing unit for securing said first end portion of said camera housing on said first wall portion of said recess-defining wall, said securing unit including
an anchoring piece that is anchored to said second surface of said first wall portion of said recess-defining wall, and
a fastening member that extends through said anchoring piece and that threadedly engages said first end portion of said camera housing.
